(19) United States
(12) Patent Application Publication
(10) Pub. No.: US 2022/0357991 A1
(43) Pub. Date: Nov. 10, 2022

(54) INFORMATION PROCESSING APPARATUS, COMPUTER-READABLE RECORDING MEDIUM STORING AGGREGATION CONTROL PROGRAM, AND AGGREGATION CONTROL METHOD

(71) Applicant: FUJITSU LIMITED, Kawasaki-shi (JP)

(72) Inventors: Takahisa Suzuki, Yokohama (JP); Ryuichi MATSUKURA, Kawasaki (JP); Shinya Toyonaga, Kawasaki (JP); MIHO KAWANO, Hamamatsu (JP)

(73) Assignee: FUJITSU LIMITED, Kawasaki-shi (JP)

(21) Appl. No.: 17/666,069

(22) Filed: Feb. 7, 2022

(30) Foreign Application Priority Data
May 7, 2021 (JP) 2021-079279

(51) Int. Cl. G06F 9/50; G06N 20/00

(52) U.S. Cl. CPC G06F 9/5016; G06N 20/00

(57) ABSTRACT

An apparatus of controlling applications each of which is an application performing processing on a moving image using a graphical processing unit (GPU), the apparatus including: a memory configured to store, for each application, identification information of a learning model, an operation cycle, a time length requested for one frame, and usage of the memory by the learning model; and a processor configured to perform: determining, for each learning model by using various information stored for each application, aggregation necessity indicating whether to aggregate sets of processing performed by the applications, and the number of processes to be used for the aggregation, wherein the various information includes the identification information, the operation cycle, the time length, and the usage of the memory; and aggregating and executing sets of processing performed by the applications based on a different from a process for performing the applications.

### CROSS-REFERENCE TO RELATED APPLICATION

This application is based upon and claims the benefit of priority of the prior Japanese Patent Application No. 2021-79279, filed on May 7, 2021, the entire contents of which are incorporated herein by reference.

### FIELD

The embodiment discussed herein is related to an information processing apparatus, a computer-readable recording medium storing an aggregation control program, and an aggregation control method.

### BACKGROUND

In recent years, systems that execute artificial intelligence (AI) processing using a graphical processing unit (GPU) have been increasing. For example, there is a system that performs object detection or the like by AI processing of a video.

In such a system, one GPU processes videos transferred from one camera. However, since the videos are sent at regular intervals, time when the GPU is not used is generated between pieces of processing. It is expected that one GPU accommodates and processes videos transferred from a plurality of cameras so that the time when the GPU is not used is not generated and the GPU is efficiently used.

For example, a disclosure has been made concerning a technique of an object detection process in which processes by a plurality of learning models are executed sequentially (one after another in order) or in parallel.

In a case where video processes by the plurality of learning models are executed in parallel, a GPU memory capacity is requested for the plurality of learning models involved in the parallel execution.

Examples of the related art include as follows: Japanese Laid-open Patent Publication Nos. 2002-83297 and 2020-112937 and U.S. Patent Application Publication No. 2014/0270429.

### SUMMARY

According to an aspect of the embodiments, there is provided an information processing apparatus configured to control a plurality of application, each of the plurality of applications being an application performing processing on a moving image using a graphical processing unit (GPU), the information processing apparatus including: a memory configured to store, for each of the plurality of applications, identification information of, among a plurality of learning models, a learning model to be used by the processing of that application, an operation cycle of the processing of that application, a processing time length requested for one frame of the processing of that application, and usage of the memory by the learning model; and a processor coupled to the memory, the processor being configured to perform: executing a determination processing that determines, for each of the plurality of learning models by using various information stored for each of the plurality of the applications, aggregation necessity indicating whether to aggregate sets of processing performed by applications which are any two or more of the plurality of applications and use that learning model, and a number of processes to be used for the aggregation, each of the applications being an application using that learning model, wherein the various information includes the identification information of that learning models, the operation cycle, the processing time length, and the usage of the memory by that learning model; and in response to the determining of the aggregation necessity indicating that the sets of processing performed by the applications are to be aggregated, executing an execution processing that aggregates and executes the sets of processing performed by the applications, by using a process different from a process for performing the applications.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a functional configuration of a system including an execution server according to an embodiment;

FIG. 2 is a diagram illustrating aggregation control according to the embodiment;

FIG. 3 illustrates an example of a functional configuration of the execution server according to the embodiment;

FIG. 4 illustrates an example of a data structure of profile information according to the embodiment;

FIG. 5 illustrates an example of a data structure of aggregation target information according to the embodiment;

FIG. 6 illustrates an example of how to determine the number of aggregations;

FIG. 7 illustrates another example of how to determine the number of aggregations;

FIG. 8 illustrates an example of a flowchart of an aggregation target determination processing according to the embodiment;

FIG. 9 illustrates an example of a flowchart of an execution control processing according to the embodiment;

FIG. 10 illustrates an example of a flowchart of processing result reception processing according to the embodiment;

FIG. 11 illustrates an example of a hardware configuration of the execution server; and

FIG. 12 illustrates a problem of bad efficiency of use of a GPU memory.

### DESCRIPTION OF EMBODIMENTS

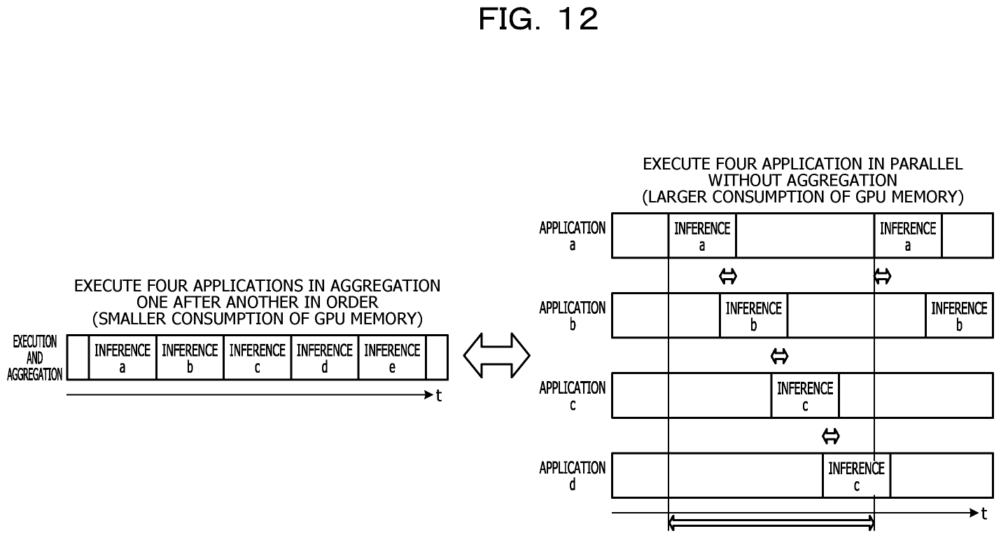

However, in the case where the plurality of video processes by a single GPU are executed in parallel, it is problem that the efficiency of use of the GPU memory deteriorates. The problem will be described. FIG. 12 is a diagram for explaining the problem of deterioration in the efficiency of use of the GPU memory. As illustrated in the left half of FIG. 12, a single GPU executes a plurality of processes one after another in order. This illustrates a case where four pieces of video inference processing are being performed one after another in order. All the pieces of inference processing are performed using the single learning model. In such a case, the GPU aggregates all the pieces of inference processing and then performs them one after another in order. For this reason, usage of GPU memory illustrates usage of memory requested for one learning model.

As illustrated in the right half of FIG. 12, a single GPU may perform four pieces of video inference processing in parallel. In such a case, though the GPU uses the same learning model, the usage of the GPU memory illustrates the usage of memory requested for the pieces of processing by the learning model involved in the parallel execution. For example, in a case where all the pieces of inference processing are executed in parallel without aggregation, the usage of the GPU memory is greater than in a case where all the pieces of inference processing in aggregation are executed one after another in order. For example, in the case where a single GPU performs a plurality of pieces of video inference processing in parallel, the usage of the GPU memory is assumed to exceed total usage of the GPU memory capacity, and the efficiency of use of the GPU memory becomes worse.

A purpose of one aspect of the present embodiment is to increase the efficiency of use of a GPU memory in a case where a single GPU performs a plurality of pieces of video processing.

Hereinafter, embodiments of an information processing apparatus, an aggregation control program, and aggregation control method disclosed in the present application will be described in detail with reference to the drawings. The present disclosure is not limited by the embodiments.

[Embodiment]

[Configuration of System]

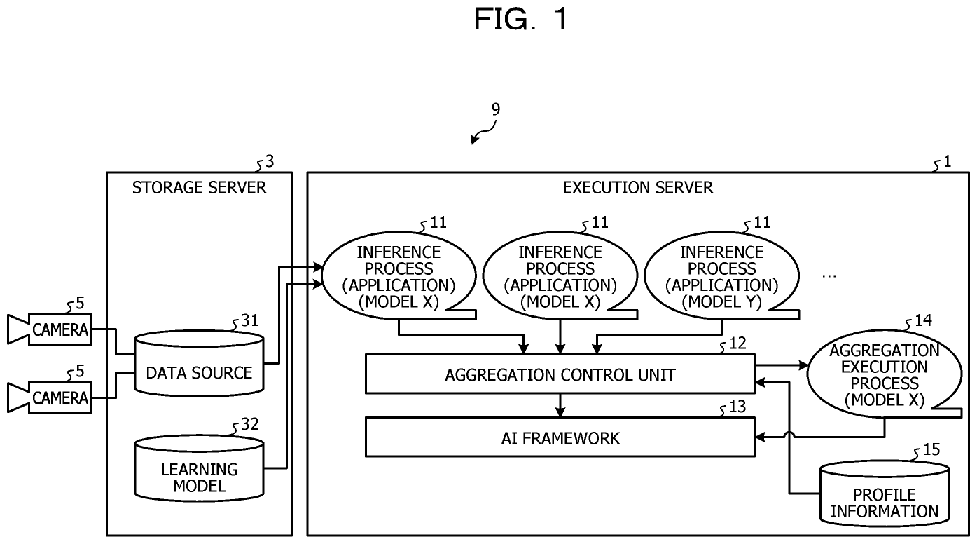

FIG. 1 illustrates an example of a functional configuration of a system including an execution server according to the embodiment. A system 9 includes an execution server 1, a storage server 3, and a plurality of cameras 5. The system 9 executes, in the execution server 1 on which a GPU is mounted, an inference process 11 (application) that performs inference processing on a moving image (video). It is assumed that the system 9 executes a plurality of inference processes 11 with one GPU. For example, the inference process 11 referred to in this case is an application for estimating a suspicious person from a video output from the camera 5 or estimating traffic. The inference process 11 incorporates a predetermined library of an AI framework 13 and executes inference processing by using a learning model 32.

The storage server 3 includes a data source 31 of videos output respectively from the plurality of cameras 5, and the learning model 32. The learning model 32 is a model used for the inference processing of the inference process 11.

In the execution server 1, an aggregation control unit 12 is provided between the plurality of inference processes 11 and an AI framework 13. The execution server 1 includes profile information 15.

The AI framework 13 executes inference processing by an inference process 11 and an aggregation execution process 14 described below. The AI framework 13 is a library for performing inference processing on a video, and is incorporated in the inference process 11 and the aggregation execution process 14. The AI framework 13 is, for example, called by the inference process 11, and executes inference processing. Examples of the AI framework 13 include TensorFlow, MXNet, Pytorch, and the like.

The profile information 15 is information generated for each of the plurality of inference processes 11 (applications), and associating a learning model 32 used by each application with an inference processing operation cycle (frame rate), a one-frame processing time length, and usage of memory in a GPU 22. The profile information 15 will be described in detail.

Before the aggregation control is put into operation, for each learning model 32, the aggregation control unit 12 determines aggregation necessity indicating whether to aggregate the inference processing of the applications of the respective inference processes 11 going to use the learning model 32, and the number of aggregations, based on the profile information 15. The number of aggregations referred to herein means the number of processes to be used for the aggregation execution. Each of the processes is the aggregation execution process 14. While the aggregation control is in operation, the aggregation control unit 12 makes control so that the aggregation execution process 14, which is different from the inference processes 11, performs the inference processing of the applications using the learning model 32, which is determined to be aggregated. For example, while monitoring inference requests from the inference processes 11 to the AI framework 13, the aggregation control unit 12 controls the destinations of the inference requests in order to make the aggregation execution process 14 perform inference on the inference requests from the applications using the learning models 32 which are aggregation targets.

[Description of Aggregation Control]

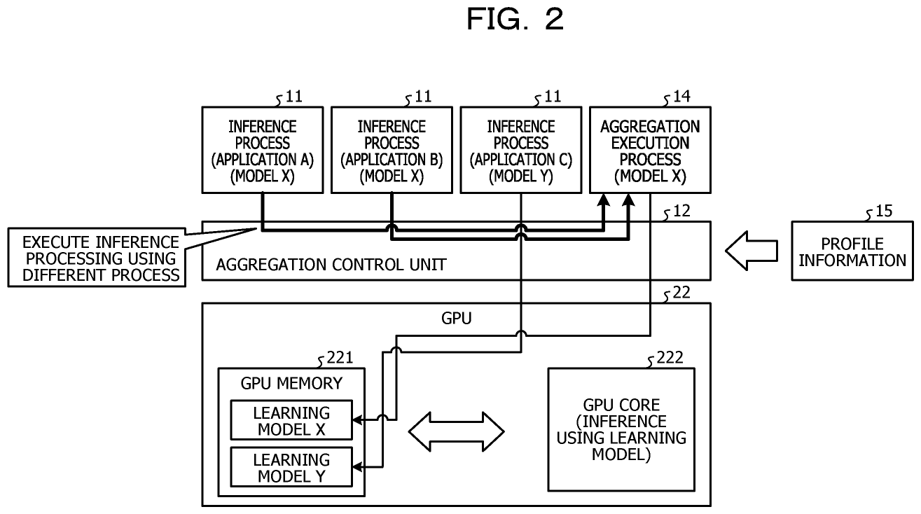

The aggregation control according to the embodiment will be described with reference to FIG. 2. FIG. 2 is a diagram illustrating aggregation control to the embodiment. As illustrated in FIG. 2, based on the profile information 15 and the capacity of a memory mounted on the GPU 22, the aggregation control unit 12 determines the learning models 32 which are the aggregation targets, and the number of aggregation execution processes 14 to be executed in aggregation (the number of aggregations). The aggregation control unit 12 makes control so that the sets of inference processing of the applications using the learning models 32 which are the aggregation targets are performed using the aggregation execution process 14 which is the process different from the inference processes 11. The aggregation control unit 12 makes control so that the sets of inference processing of the applications using the learning models 32 which are not the aggregation targets are directly performed from the inference processes 11 of the applications.

The inference process 11 of the inference processing of an application A is activated. The inference processing of the application A uses a learning model X. The inference process 11 of the inference processing of an application B is activated. The inference processing of the application B uses the learning model X. The inference process 11 of the inference processing of an application C is activated. The inference processing of the application C uses a learning model Y. Based on the profile information 15 and the capacity of the memory mounted on the GPU 22, the aggregation control unit 12 determines that the learning model X be the learning model 32 which is the aggregation target, and that the number of aggregations be “1”. At the time of the determination, the aggregation control unit 12 activates as many aggregation execution process 14 as the number of aggregations. Thereafter, the aggregation control unit 12 performs control so as to make the aggregation execution process 14, which is the process different from the inference processes 11, perform the inference processing of the applications A, B using the learning model X which is the aggregation target. As a result, the aggregation execution process 14 aggregates the inference processing of the application A and the inference processing of the application B, and executes them one after another in order. Thereby, the usage of memory in the GPU memory 221 for the execution of the aggregation execution process 14 is the usage of memory requested for the single learning model X, and is accordingly smaller than in a case of a parallel execution.

With regard to the inference processing of the application C using the learning model Y which is not the aggregation target, the aggregation control unit 12 performs control so as to make the inference process 11 of the application C directly perform the inference processing. Thereby, in the case where the single GPU 22 performs the plurality of pieces the inference processing, the aggregation control unit 12 may increase the efficiency of use of the GPU memory 221. Hereinafter, the execution server 1 including such an aggregation control unit 12 will be described in detail.

[Functional Configuration of Execution Server]

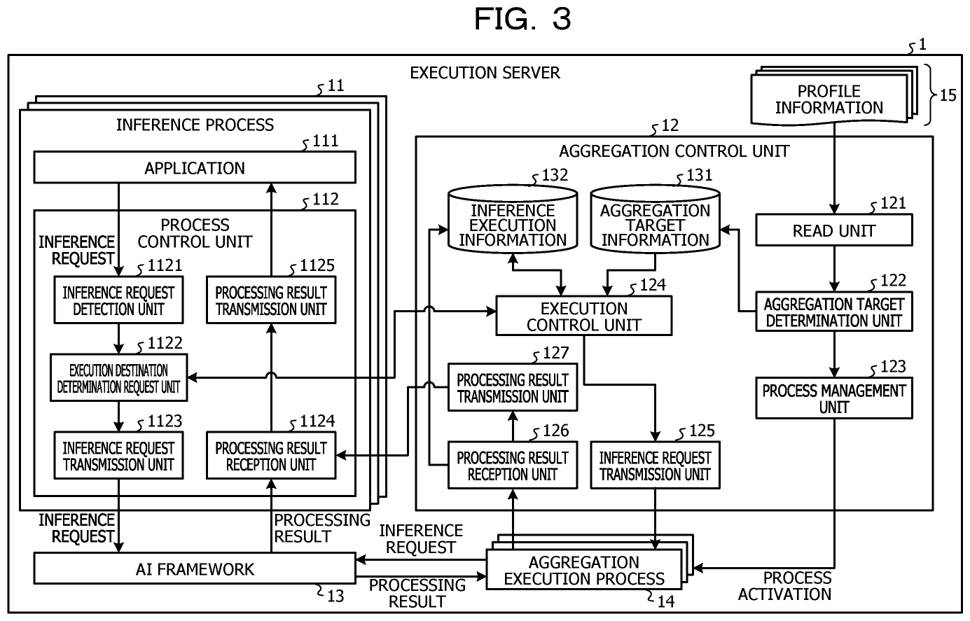

FIG. 3 illustrates an example of a functional configuration of the execution server according to the embodiment. As illustrated in FIG. 3, the functional configuration includes inference processes 11, the aggregation control unit 12, the AI framework 13, the aggregation execution processes 14, and the sets of profile information 15.

The inference processes 11 each include an application 111 and a process control unit 112. For each application 111, the corresponding inference process 11 is activated. Using the learning model 32, the application 111 performs the inference processing for each frame. The application 111 outputs an inference request the process control unit 112 when performing the inference processing for each frame. The process control unit 112 includes an inference request detection unit 1121, an execution destination determination request unit 1122, an inference request transmission unit 1123, a processing result reception unit 1124, and a processing result transmission unit 1125.

The inference request detection unit 1121 detects the inference request from each application 111. The execution destination determination request unit 1122 requests the aggregation control unit 12 to determine an execution destination to which to execute the inference request. For example, the execution destination determination request unit 1122 requests the aggregation control unit 12 to determine aggregation necessity indicating whether to aggregate the inference requests from the respective applications 111.

The inference request transmission unit 1123 makes its own inference process 11 executes the inference request to the AI framework 13 in a case where the inference process 11 is determined as the execution destination to which to execute the inference request. For example, in a case where the inference request of the application 111 is determined not to be aggregated (the aggregation is determined as unnecessary), the inference request transmission unit 1123 makes its own inference process 11 executes the inference request to the AI framework 13.

In the case where the inference request is determined not to be aggregated (the aggregation is determined as unnecessary), the processing result reception unit 1124 receives a processing result from the AI framework 13. In a case where the inference request is determined to be aggregated (the aggregation is determined as requested), the processing result reception unit 1124 receives a processing result from the aggregation control unit 12.

The processing result transmission unit 1125 returns the received processing result to the application 111.

The aggregation control unit 12 includes a read unit 121, an aggregation target determination unit 122, a process management unit 123, an execution control unit 124, an inference request transmission unit 125, a processing result reception unit 126, and a processing result transmission unit 127. The aggregation control unit 12 further includes an aggregation target information 131, and an inference execution information 132.

The read unit 121 reads the profile information 15. The profile information 15 referred to herein is, for example, information to be used to determine learning models 32 which are aggregation targets, and the number of aggregation execution processes 14 to be executed in aggregation (the number of aggregations). The profile information 15 is beforehand set up for each application 111.

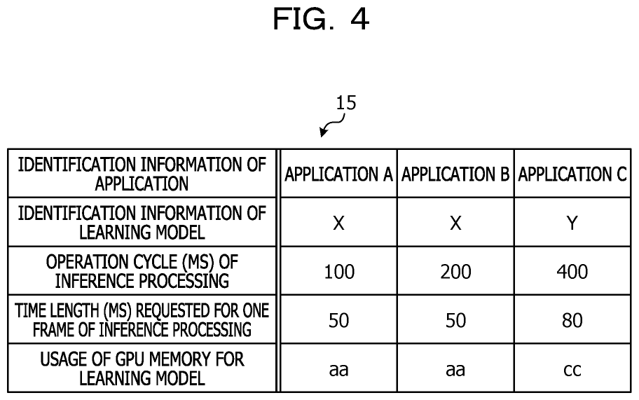

An example of a data structure of the profile information 15 will be described with reference to FIG. 4. FIG. 4 illustrates an example of a data structure of profile information according to the embodiment. As illustrated in FIG. 4, each set of profile information 15 is information which associates application identification information, learning model identification information, an inference processing operation cycle, a one-frame inference processing time length, and usage of a GPU memory for the learning model. The application identification information indicates the name of the application 111 or the process ID (Identifier) of the inference process 11. The learning model identification information indicates the model name or identification ID of the learning model 32 used by the application 111. The Inference processing operation cycle indicates a time length from the start of a first inference processing immediately before the start of a second inference processing. The one-frame inference processing time length indicates a time length requested for one-frame inference processing. A time unit of the operation cycle and the inference processing time length is, for example, millisecond (ms). The usage of the GPU memory for the learning model indicates the usage of the GPU memory 221 for the learning model 32.

The one-frame inference processing operation cycles and the usage of the GPU memory for the respective learning models are equal among the learning models if the same learning model 32 is used as the learning models. For example, in a case where the application identification information is “Application A”, the profile information stores “X” as the learning model identification information, “100” as the inference processing operation cycle, “50” as the one-frame inference processing time length, and “aa” as the usage of the GPU memory for the learning model. In a case where the application identification information is “Application B”, the profile information stores “X” as the learning model identification information, “200” as the inference processing operation cycle, “50” as the one-frame inference processing time length, and “aa” as the usage of the GPU memory for the learning model. In a case where the application identification information is “Application C”, the profile information stores “Y” as the learning model identification information, “400” as the inference processing operation cycle, “80” as the one-frame inference processing time length, and “cc” as the usage of the GPU memory for the learning model.

Returning to FIG. 3, based on the sets of profile information 15, the aggregation target determination unit 122 determines the learning model 32 as the aggregation target, and the number of aggregation execution processes 14 to be executed in aggregation (the number of aggregations).

For example, based on each inference processing operation interval (operation cycle) and each inference processing time length, for the applications 111 to use the same learning model 32, the aggregation target determination unit 122 determines the number of aggregation execution processes 14 (the number of aggregations) in a way that enables the applications 111 to be processed even in aggregation within the operation cycle. Each inference processing operation interval and each inference processing time length are obtained from the inference processing operation cycle and the one-frame inference processing time length corresponding each application 111 in the sets of profile information 15. Using the one-frame inference processing time lengths and the operation intervals (operation cycles) each of the applications 111 to use the same learning model 32, the aggregation target determination unit 122 calculates a value (the number after the decimal point rounded up) to be obtained by totaling the one-frame inference processing time lengths/the operation intervals. The aggregation target determination unit 122 determined the value obtained by the calculation as the number of aggregations of the learning models 32 which are the aggregation targets. The one-frame inference processing time lengths/the operation intervals (operation cycles) of one application 111 referred to herein means a proportion at which the GPU is occupied by the inference processing per unit time. Accordingly, in a case where the total (the number after the decimal point rounded up) of the inference processing time lengths/the operation intervals of the plurality of applications 111 as the targets does not exceed the unit time, one aggregation execution process 14 may execute the inference processing of each application 111 within each operation interval. On the other hand, in a case where the total (the number after the decimal point rounded up) of the inference processing time lengths/the operation intervals of the plurality of applications 111 as the targets exceeds the unit time, as many aggregation execution processes 14 as the value obtained from the total (the number after the decimal point rounded up) may execute the inference processing of each application 111 within each operation interval.

The aggregation target determination unit 122 determines the learning models 32 as the aggregation targets whose inference processing is to be aggregated in a way that performs the inference processing within the capacity of the memory mounted on the GPU 22.

For example, for each learning model 32, the aggregation target determination unit 122 calculates the total usage of the GPU memory 221 with aggregation and with no aggregation, from the memory capacity of the GPU memory 221 and the determined number of aggregations. The total usage Z1 of the GPU memory 221 for the learning models 32 as the aggregation targets with aggregation is calculated using Equation (1) expressed below.

The total usage Z1 of the GPU memory 221 with aggregation=the number of aggregations×the usage of the GPU memory . . . (1)

The total usage Z2 of use of the GPU memory 221 for the case where no aggregation is performed on the learning model 32 as the aggregation target is calculated using Equation (2) expressed below.

The total usage Z2 of the GPU memory 221 for the case where no aggregation is performed=the number of inference processes 11 using the learning models 32 as the targets×the usage of the GPU memory . . . (2)

The usage of the GPU memory expressed in Equations (1) and (2) may be obtained from the usage of the GPU memory for the learning models corresponding to the applications 111 using the learning models 32 as the targets in the sets of profile information 15.

The aggregation target determination unit 122 calculates the total usage of the GPU memory 221 for the case where no aggregation is performed on any of the learning models 32 put in use. If the total usage of the GPU memory 221 for the case where no aggregation is performed on any of the learning models 32 is smaller than the capacity of the memory mounted on the GPU 22, the aggregation target determination unit 122 determines none of the learning models 32 as the aggregation targets. For example, the aggregation target determination unit 122 determines to execute the inference processes 11 of the applications 111 for the learning models 32 in parallel without aggregating the inference processes 11.

If the total usage of the GPU memory 221 for the case where no aggregation is performed on any of the learning models 32 is equal to or greater than the capacity of the memory mounted on the GPU 22, the aggregation target determination unit 122 determines the learning models 32 as the aggregation targets by giving higher priority to the larger aggregation effect. For example, for each learning model 32, the aggregation target determination unit 122 calculates the difference between the total usage of the GPU memory 221 with aggregation and the total usage of the GPU memory 221 with no aggregation. The difference Z3 between the total usage of the GPU memory 221 memory for the learning model 32 as the target is calculated using Equation (3) expressed below.

The difference Z3 between the total usage of the GPU memory 221=the number of inference processes×the usage of the GPU memory−the number of aggregations×the usage of the GPU memory . . . (3)

Giving higher priority to the larger differences Z3 between the total usage of the GPU memory 221, the aggregation target determination unit 122 determines the learning models 32 to be aggregated as the aggregation targets in order of high to low priority.

The aggregation target determination unit 122 calculates the total usage of the GPU memory 221 by aggregating the determined learning models 32, and without aggregating the other learning models 32. The total usage of the GPU memory 221 for the learning models 32 to be aggregated may be calculates using Equation (1). The total usage of the GPU memory 221 for the learning models 32 to be not aggregated may be calculated using Equation (2).

In a case where the calculated total usage of the GPU memory 221 is smaller than the capacity of the memory mounted on the GPU 22, the aggregation target determination unit 122 terminates the aggregation target determination processing since the calculated total amount falls within the capacity of the GPU memory 221. In a case where the calculated total usage of the GPU memory 221 is equal to or greater than the capacity of the memory mounted on the GPU 22, the aggregation target determination unit 122 performs the following processing. Since the calculated total amount does not fall within the capacity of the GPU memory 221, the aggregation target determination unit 122 increase the learning models 32 to be aggregated in order of high-to-low priority, and determines the learning models 32 as the aggregation targets in a way that makes the total usage of the GPU memory 221 fall within the capacity of the GPU memory 221.

The process management unit 123 manages the aggregation execution processes 14. For example, the process management unit 123 activates the same number of aggregation execution processes 14 as the number of aggregations of the learning models 32 having been determined as the aggregation targets by the aggregation target determination unit 122. The aggregation target determination unit 122 records the sets of identification information of the respective applications 111 using the learning models 32 into a target application list included in the aggregation target information 131 while associating the sets of identification information of the applications 111 with the sets of identification information of the learning models 32 having been determined as the aggregation targets. The aggregation target determination unit 122 further records the process IDs of the aggregation execution processes 14 into an aggregation execution process list included in the aggregation target information 131 while associating the process IDs with the sets of identification information of the learning models 32 having been determined as the aggregation targets.

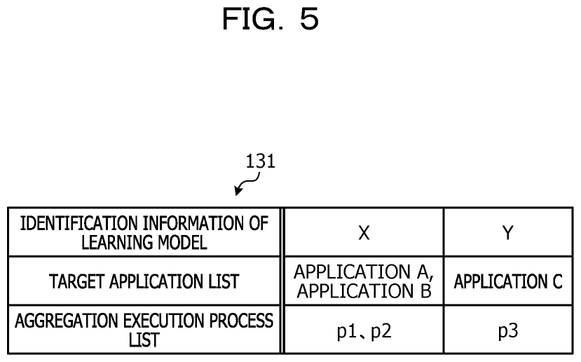

An example of a data structure of the aggregation target information 131 will be described with reference to FIG. 5. FIG. 5 illustrates an example of a data structure of aggregation target information according to the embodiment. As illustrated in FIG. 5, the aggregation target information 131 is information associating the sets of learning model identification information, the target application list, and the aggregation execution process list with one another. Each set of the learning model identification model indicates the model name or identification ID of the corresponding learning model 32. The target application list indicates the names of the applications 111 using the learning models 32, or the process IDs of the inference processes 11. The aggregation execution process list indicates the process IDs of as many as aggregation execution processes 14 as the number of aggregations corresponding to the learning models 32.

Returning to FIG. 3, the execution control unit 124 controls the execution of the inference requests. For example, from the inference processes 11, the execution control unit 124 receives requests to determine execution destinations of the inference requests. Referring to the aggregation target information 131, the execution control unit 124 determines whether or not learning models 32 corresponding to the sets of identification information of applications 111 included in the requests are aggregation targets. In a case where the learning models 32 as the targets are not the aggregation targets, the execution control unit 124 gives inference processes 11 as the request sources back an answer that the execution destination destinations of the inference request are the request sources. In a case where the learning models 32 as the targets are the aggregation targets, the execution control unit 124 refers to the aggregation execution process list included in the aggregation target information 131, and obtains the availability conditions of the aggregation execution processes 14 corresponding to the learning models 32 as the targets. If the aggregation execution processes 14 as the targets are available, the execution control unit 124 selects one of the available aggregation execution processes 14, and instructs the inference request transmission unit 125 to transmit the inference request. If none of the aggregation execution processes 14 as the targets are available, the execution control unit 124 stands by until any one of the aggregation execution processes 14 as the targets becomes available.

Based on the instruction of the execution control unit 124, the inference request transmission unit 125 transmits the inference request to the aggregation execution process 14 as the target. For example, the inference request transmission unit 125 transmits the inference request to the aggregation execution process 14 as the target in order to make the aggregation execution process 14, different from the inference processes 11, execute the inference request. The inference request transmission unit 125 changes the status of the aggregation execution process 14 as the targets to “Processing Is Ongoing”. The inference execution information 132 may manage the status of the aggregation execution process 14.

The processing result reception unit 126 receives a processing result from the aggregation execution process 14 as the target which has executed the inference request. The processing result reception unit 126 changes the status of the aggregation execution process 14 as the target to “Available”. The inference execution information 132 may manage the status of the aggregation execution process 14. The processing result transmission unit 127 transmits the processing result to the inference process 11 as the request source.

Each aggregation execution process 14 is a process for executing the inference processing of the corresponding application 111 using a learning model 32 as an aggregation target. For example, the aggregation execution process 14 is a process different from any of the inference processes 11 for executing the inference processing of the applications 111. The aggregation execution process 14 transmits the inference request to the AI framework 13. Upon receipt of the processing result from the AI framework 13, the aggregation execution process 14 returns the received processing result to the processing result reception unit 126.

[Example of How to Determine the Number of Aggregations]

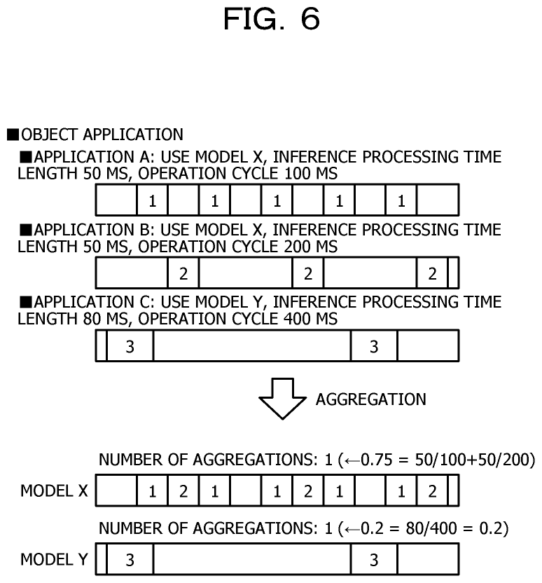

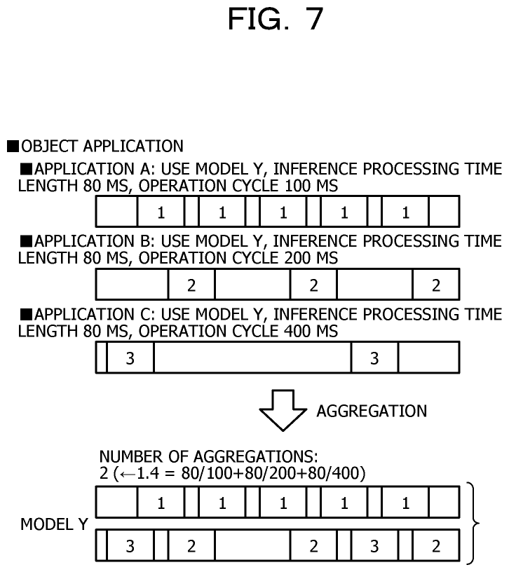

Referring to FIGS. 6 and 7, descriptions will be provided for how the aggregation target determination unit 122 determines the number of aggregations. FIG. 6 illustrates an example of how to determine the number of aggregations. As illustrated in FIG. 6, concerning information on an application A indicating an application 111 as a target, “X”, “50 ms”, and “100 ms” are set up as “a use model”, “an inference processing time length”, and “an operation cycle”, respectively. Concerning information on an application B, “X”, “50 ms”, and “200 ms” are set up as “a use model”, “an inference processing time length”, and “an operation cycle”, respectively. Concerning information on an application C, “Y”, “80 ms”, and “400 ms” are set up as “a use model”, “an inference processing time length”, and “an operation cycle”, respectively. The use models X, Y referred to herein correspond to the “learning model identification information” included in each set of profile information 15. Each inference processing time length referred to herein indicates the “one-frame inference processing time length” included in the set of profile information 15. Each operation cycle corresponds to the “inference processing operation cycle” included in the corresponding set of profile information 15.

Under such a situation, using the one-frame inference processing time length and the operation cycle of each of the applications 111 using the same learning model 32, the aggregation target determination unit 122 calculates a value (the number after the decimal point rounded up) to be obtained by totaling the one-frame inference processing time lengths/the operation cycles. The aggregation target determination unit 122 determined the value obtained by the calculation as the number of aggregations of the learning models 32 which are the aggregation targets. For example, for the sets of inference processing using the same learning model 32, the aggregation target determination unit 122 determines the number of aggregation execution processes 14 (the number of aggregations) from the respective operation cycles and inference processing time lengths in a way that enables the sets of inference processing to be processed even in aggregation within the operation cycles.

Because a value obtained by adding up “50/100” concerning the application A and “50/200” concerning the application B is calculated as “0.75”, the number after the decimal point is rounded up to the nearest whole number. Accordingly, the number x of aggregations of the models X is calculated as “1”. As illustrated in the lower half of FIG. 6, even if the applications A and B using the learning model X are aggregated into a single aggregation execution process 114, the applications A and B may be processed within the respective operation cycles.

Because a value obtained by calculating “80/400” concerning the application C is calculated as “0.2”, the number after the decimal point is rounded up to the nearest whole number. Accordingly, the number y of aggregations of the model Y is calculated as “1”. As illustrated in the lower half of FIG. 6, even though the application C using the learning model Y is aggregated into a single aggregation execution process 114, the applications C may be processed within the corresponding operation cycle.

The sets of inference processing to be executed in the respective processes are executed in parallel by the GPU 22.

[Another Example of How to Determine the Number of Aggregations]

FIG. 7 illustrates another example of how to determine the number of aggregations. As illustrated in FIG. 7, concerning information on an application A indicating an application 111 as a target, “Y”, “80 ms”, and “100 ms” are set up as “a use model”, “an inference processing time length”, and “an operation cycle”, respectively. Concerning information on an application B, “Y”, “80 ms”, and “200 ms” are set up as “a use model”, “an inference processing time length”, and “an operation cycle”, respectively. Concerning information on an application C, “Y”, “80 ms”, and “400 ms” are set up as “a use model”, “an inference processing time length”, and “an operation cycle”, respectively. The use model Y referred to herein corresponds to a “learning model identification information” includes in a set of profile information 15. Each inference processing time length referred to herein indicates the “one-frame inference processing time length” included in the set of profile information 15. Each operation cycle corresponds to the “inference processing operation cycle” included in the corresponding set of profile information 15.

Under such a situation, using the one-frame inference processing time length and the operation cycle of each of the applications 111 using the same learning model 32, the aggregation target determination unit 122 calculates a value (the number after the decimal point rounded up) to be obtained by totaling the one-frame inference processing time lengths/the operation cycles. The aggregation target determination unit 122 determined the value obtained by the calculation as the number of aggregations of the learning models 32 which are the aggregation targets. For example, for the sets of inference processing using the same learning model 32, the aggregation target determination unit 122 determines the number of aggregation execution processes 14 (the number of aggregations) from the respective operation cycles and inference processing time lengths in a way that enables the sets of inference processing to be processed even in aggregation within the operation cycles.

Because a value obtained by adding up “80/100” concerning the application A, “80/200” concerning the application B, and “80/400” concerning the application C is calculated as “1.4”, the number y of aggregations of the models Y is calculated as “2” by rounding the number after the decimal point up to the nearest whole number. For example, the models Y are aggregated into two models. The sets of inference processing using the applications A, B, and C using the model Y are executed in parallel by the GPU 22. As illustrated in the lower half of FIG. 7, even if the applications A, B, and C using the learning model Y are aggregated into two aggregation execution processes 114, the applications A, B, and C may be processed within the respective operation cycles.

[Flowchart of Aggregation Target Determination Processing]

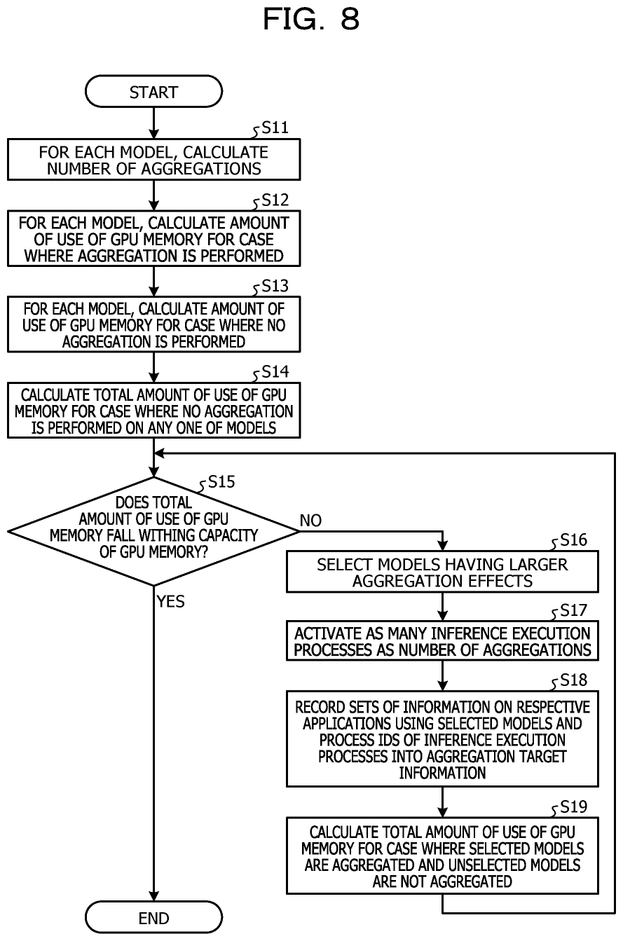

FIG. 8 illustrates an example of a flowchart of aggregation target determination processing according to the embodiment. The aggregation target determination processing is executed before the operation of the aggregation control.

As illustrated in FIG. 8, for each learning model 32, the aggregation target determination unit 122 calculates the number of aggregations (step S11). For example, for each learning model 32, the aggregation target determination unit 122 obtains the one-frame inference processing time lengths and operation cycles of the respective applications 111 from the corresponding set of profile information 15. For each learning model 32, the aggregation target determination unit 122 calculates a value (the number after the decimal point rounded up) to be obtained by adding up the one-frame inference processing time lengths/the operation cycles, and calculates the number of aggregations of the learning models 32.

For each learning model 32, the aggregation target determination unit 122 calculates the usage of the GPU memory for the aggregation (step S12). For example, for each learning model 32, using the number of aggregations and the usage of the GPU memory, the aggregation target determination unit 122 calculates the total usage Z1 of the GPU memory 221 with aggregations (see Equation (1)). The usage of the GPU memory may use the usage of the GPU memory for the learning model 32 as the target which is included in the corresponding set of profile information 15.

For each learning model 32, the aggregation target determination unit 122 calculates the usage of the GPU memory for the case where no aggregation is performed (step S13). For example, for each learning model 32, the aggregation target determination unit 122 calculates the total usage Z2 of the GPU memory 221 for the case where no aggregation is performed, using the number of inference processes 11 using the learning models 32 and the usage of the GPU memory (see Equation (2)). The number of inference processes 11 using the learning models 32 as the targets corresponds to the number of applications 111 corresponding to the learning models 32 as the targets which are included in the sets of profile information 15. The usage of the GPU memory may use the usage of the GPU memory for the learning model 32 as the target which is included in the corresponding set of profile information 15.

The aggregation target determination unit 122 calculates the total usage of the GPU memory for the case where no aggregation is performed on any one of the learning models 32 (step S14). For example, the aggregation target determination unit 122 may calculate the total usage of the GPU memory for the case where no aggregation is performed, by adding up the usage of the GPU memory respectively for the cases where no aggregation is performed on the learning models 32.

The aggregation target determination unit 122 determines whether the total usage of the GPU memory falls within the capacity of the GPU memory 221 (step S15). If the aggregation target determination unit 122 determines that the total usage of the GPU memory falls within the capacity of the GPU memory 221 (Yes in step S15), the aggregation target determination unit 122 terminates the aggregation target determination processing.

If the aggregation target determination unit 122 determines that the total usage of the GPU memory does not fall within the capacity of the GPU memory 221 (No in step S15), the aggregation target determination unit 122 selects a learning model 32 which increases the aggregation effect (step S16). For example, for each learning model 32, the aggregation target determination unit 122 calculates the difference Z3 between the total usage of the GPU memory 221 with aggregation and the total usage of the GPU memory 221 with no aggregation (see Equation (3)). The aggregation target determination unit 122 selects learning models 32 in order from the largest difference Z3 between the total usage to the smallest difference Z3 between the total use amounts.

The process management unit 123 activates as many aggregation execution processes 14 as the number of aggregations corresponding to the selected learning models 32 (step S17). The process management unit 123 records the sets of identification information of the applications 111 using the selected learning models 32 and the process IDs of the aggregation execution processes 14 into the aggregation target information 131 (step S18).

Subsequently, the aggregation target determination unit 122 calculates the total usage of the GPU memory for the case where the selected learning models 32 are aggregated and the other learning models 32 are not aggregated (step S19). The total usage of the GPU memory 221 for the selected learning models 32 with aggregation may be calculated using Equation (1). The total usage of the GPU memory 221 for the case where no aggregation is performed on the other learning models 32 may be calculated using Equation (2). The aggregation target determination unit 122 proceeds to step S15 in order to determine whether the calculated total usage of the GPU memory falls within the capacity of the GPU memory 221.

[Flowchart of Execution Control Processing]

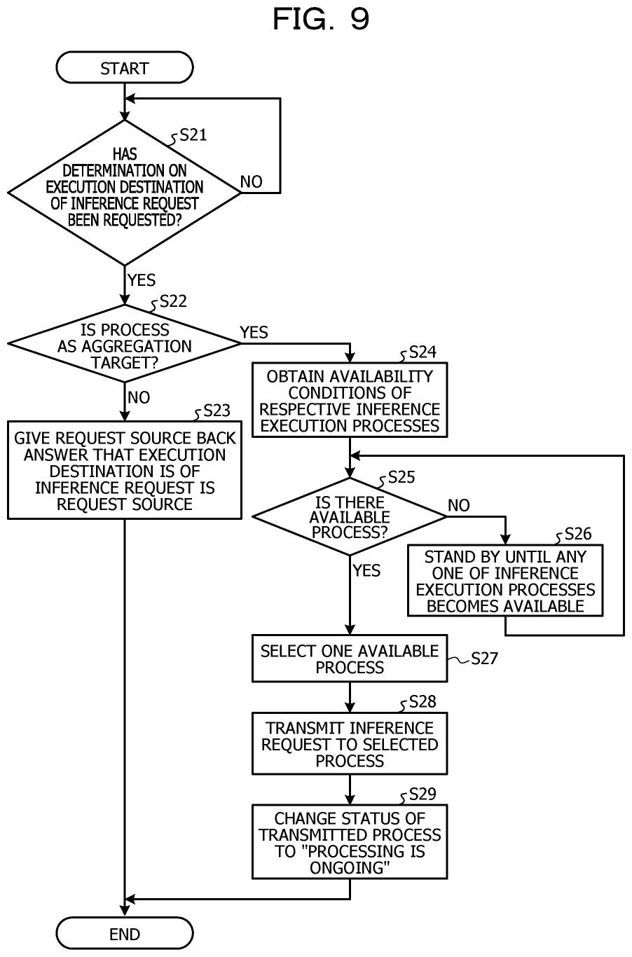

FIG. 9 illustrates an example of a flowchart of an execution control processing according to the embodiment. As illustrated in FIG. 9, the execution control unit 124 determines whether the execution control unit 124 has been requested to determine an execution destination of an inference request (step S21). If the execution control unit 124 determines that the execution control unit 124 has not been requested to determine the destination where to execute the inference request (No in step S21), the execution control unit 124 repeats the determination processing until the execution control unit 124 is requested to determine an execution destination of an inference request.

If the execution control unit 124 determines that the execution control unit 124 has been requested to determine an execution destination of an inference request (Yes in step S21), the execution control unit 124 determines whether the request source is an inference process 11 as an aggregation target (step S22). For example, referring to the aggregation target information 131, the execution control unit 124 determines whether a learning model 32 corresponding to the identification information of an application 111 included in the request is an aggregation target.

If the execution control unit 124 determines that the request source is not the inference process 11 as the aggregation target (No in step S22), the execution control unit 124 gives the request source back an answer that the execution destination of the inference request is the request source (step S23). The execution control unit 124 terminates the execution control processing.

If the execution control unit 124 determines that the request source is the inference process 11 as the aggregation target (Yes in step S22), the execution control unit 124 obtains availability conditions of the respective aggregation execution processes 14 corresponding to the learning models 32 as the targets (step S24). The execution control unit 124 determines whether or not there exists an available aggregation execution process 14 (step S25).

If the execution control unit 124 determines that there exists no available aggregation execution process 14 (No in step S25), the execution control unit 12 stands by until any one of the aggregation execution processes 14 as the targets becomes available (step S26). The execution control unit 124 proceeds to step S25. If the execution control unit 124 determines that there exist available aggregation execution processes 14 (Yes in step S25), the execution control unit 124 selects one of the available aggregation execution processes 14 (step S27).

The inference request transmission unit 125 transmits an inference request to the selected aggregation execution process 14 (step S28). The inference request transmission unit 125 changes the status of the aggregation execution process 14, managed in the inference execution information 132, to which the inference request transmission unit 125 transmits the inference request, into “Processing Is Ongoing” (step S29). The execution control unit 124 and the inference request transmission unit 125 terminates the execution control processing.

[Flowchart of Processing Result Reception Processing]

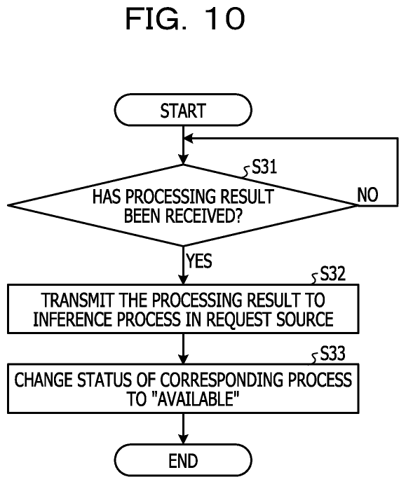

FIG. 10 illustrates an example of a flowchart of processing result reception processing according to the embodiment. As illustrated in FIG. 10, the processing result reception unit 126 determines whether a processing result has been received (step S31). When it is determined that the processing result has not been received (No in step S31), the processing result reception unit 126 repeats the determination processing until the processing result is received.

On the other hand, when it is determined that the processing result has been received (Yes in step S31), the processing result reception unit 126 transmits the processing result to the inference process 11 which is the request source (step S32). The processing result reception unit 126 changes the status of the corresponding aggregation execution process 14 into “Available” (step S33). The processing result reception unit 126 ends the processing result reception processing.

[Hardware Configuration of Execution Server]

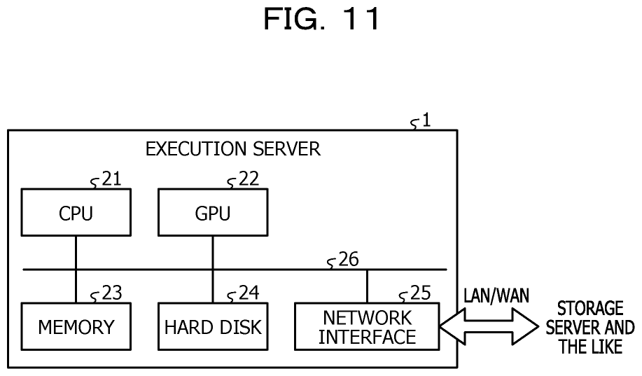

FIG. 11 illustrates an example of a hardware configuration of the execution server. As illustrated in FIG. 11, the execution server 1 includes a GPU 22 in addition to a central processing unit (CPU) 21. The execution server 1 includes a memory 23, a hard disk 24, and a network interface 25. For example, the components illustrated in FIG. 11 are coupled to each other via a bus 26.

The network interface 25 is a network interface card or the like, and communicates with other devices such as the storage server 3. The hard disk 24 stores the profile information 15 and a program for operating the functions illustrated in FIGS. 1 and 3.

The CPU 21 reads, from the hard disk 24 or the like, a program for executing the same processing as that of each processing unit illustrated in FIGS. 1 and 3 and loads the program into the memory 23, thereby causing a process of executing each function described in FIG. 1, FIG. 3, and the like to operate. For example, this process executes the same function as that of each processing unit of the execution server 1. For example, the CPU 21 reads, from the hard disk 24 or the like, a program including the same functions as those of the inference process 11, the aggregation control unit 12, the AI framework 13, the aggregation execution process 14, and the like. The CPU 21 executes a process of executing the same pieces of processing as those of the inference process 11, the aggregation control unit 12, the AI framework 13, the aggregation execution process 14, and the like.

The GPU 22 reads, from the hard disk 24 or the like, a program for executing inference processing of the inference process 11 by using the AI framework 13 illustrated in FIG. 1 and loads the program into the memory 23, thereby causing a process of executing the program to operate. The GPU 22 causes a plurality of inference processes 11 and the aggregation execution process 14 to operate in an overlapping manner.

[Effects of Embodiment]

In the above embodiment, the execution server 1 controls each application's performing the inference processing on a moving image using the GPU 22. For each the plurality of the applications, the execution server 1 stores the identification information of the learning model 32 used by the inference processing, the operation cycle of the inference processing, the one-frame inference processing time length, and the usage of the memory for the learning model 32 which are associated with the application. For each learning model 32, the execution server 1 determines the aggregation necessity indicating whether to aggregate the sets of processing performed by the applications, and the number of processes to be used for the aggregation, using the various sets of information stored for each of the plurality of the applications. The execution server 1 aggregates and executes the sets of inference processing performed by the applications using the learning models 32 determined to be aggregated, by use of the aggregation execution processes 14 different from the processes for executing the sets of inference processings performed by the applications. This configuration enables the execution server 1 to increase the efficiency of use of the GPU 22 by determining the learning models 32 as the aggregation targets.

In the above embodiment, the execution server 1 uses the identification information of the learning model 32, the inference processing operation cycle and the inference processing time length which are associated with each of the plurality of applications. For each learning model 32, the execution server 1 determines the number of processes in aggregation execution processes 14 used to aggregate the sets of inference processing performed by the applications. This configuration enables the execution server 1 to, by use of each operation cycle and each processing time length, determine the number of processes to be aggregated in the way that makes the sets of inference processing using the same learning model 32 capable of being performed within the operation cycle even which the sets of inference processing are aggregated.

The above embodiment, the execution server 1 uses the sets of identification information of the learning models 32 and the amounts of use of the memory for the learning models 32 which are associated with each of the plurality of applications, as well as the number of processes to be aggregated which are determined for each of the learning models 32. For each learning model 32, the execution server 1 calculates the usage of the memory for the learning model 32 with aggregation, and the usage of the memory for the learning model 32 with no aggregation. Using the usage of the memory for the learning model 32 with aggregation and the usage of the memory for the learning model 32 with no aggregation, which are calculated for each learning model 32, the execution server 1 determines the aggregation necessity for each learning model 32. This configuration enables the execution server 1 to increase the efficiency of use of the memory of the GPU 22.

In the above embodiment, if the total usage of the memory for the all the learning models 32 with no aggregation exceeds the capacity of the memory mounted on the GPU 22, the execution server 1 determines to preferentially aggregate some of the sets of inference processing to be performed by the learning models 32 in descending order of a difference between the usage of the memory for the learning model 32 with aggregation and the usage of the memory for the learning model 32 with no aggregation. This configuration enables the execution server 1 to increase the efficiency of use of the memory of the GPU 22 when performing the sets of inference processing.

In the above embodiment, if the total usage of the memory for the all the learning models 32 for the case where no aggregation is performed falls within the capacity of the memory mounted on the GPU 22, the execution server 1 determines to aggregate none of the sets of inference processing to be performed by all the learning models 32. The configuration enables the execution server 1 to perform the sets of inference processing of all the learning models 32 in parallel by not aggregating any one of the sets of inference processing, and to increase the time utilization efficiency of the GPU 22.

[Others]

Unless otherwise specified, processing procedures, control procedures, specific names, and information including various kinds of data and parameters described in the above-described document or drawings may be optionally changed.

Each component of the aggregation control unit 12 and the process control unit 112 included in the execution server 1 illustrated in the drawings does not necessarily have to be physically configured as illustrated in the drawings. For example, specific forms of separation and integration of each apparatus are not limited to those illustrated in the drawings, and all or a part thereof may be configured to be functionally or physically separated and integrated in certain unit depending on various loads, usage states, and the like. For example, the processing result transmission unit 1125 and the processing result reception unit 1124 may be integrated as a single unit. The processing result reception unit 126 and the processing result transmission unit 127 may be integrated into a single unit. The aggregation target determination unit 122 may be divided into a first determination unit which determines the aggregation targets, and a second determination unit which determines the number of aggregations. A storage unit (not illustrated) that stores the profile information 15 and the like may be coupled via a network as an external device of the execution server 1.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus configured to control a plurality of application, each of the plurality of applications being an application performing processing on a moving image using a graphical processing unit (GPU), the information processing apparatus comprising:
a memory configured to store, for each of the plurality of applications, identification information of, among a plurality of learning models, a learning model to be used by the processing of that application, an operation cycle of the processing of that application, a processing time length requested for one frame of the processing of that application, and usage of the memory by the learning model; and
a processor coupled to the memory, the processor being configured to perform:
executing a determination processing that determines, for each of the plurality of learning models by using various information stored for each of the plurality of the applications, aggregation necessity indicating whether to aggregate sets of processing performed by applications which are any two or more of the plurality of applications and use that learning model, and a number of processes to be used for the aggregation, each of the applications being an application using that learning model, wherein the various information includes the identification information of that learning models, the operation cycle, the processing time length, and the usage of the memory by that learning model; and
in response to the determining of the aggregation necessity indicating that the sets of processing performed by the applications are to be aggregated, executing an execution processing that aggregates and executes the sets of processing performed by the applications, by using a process different from a process for performing the applications.

2. The information processing apparatus according to claim 1, wherein
the determination processing determines, for each of the learning models, a number of processes to be used to aggregate the sets of processing performed by the applications, using the identification information of the learning model, the operation cycle of the processing, and the processing time length requested for the processing, which are associated with each of the plurality of the applications.

3. The information processing apparatus according to claim 2, wherein
the determination process calculates, for each of the plurality of learning models, a first memory amount and a second memory amount by using the identification information of the learning model, the usage of the memory for the learning model, and the number of processes for the aggregation determined for each of the learning models which are associated with each of the plurality of the applications, wherein the first memory amount corresponds to the usage of the memory for that learning model with aggregation, and the second memory amount corresponds to the usage of the memory for that learning model with no aggregation, and
the determination process determines, for each of the plurality of learning model, the aggregation necessity by using the usage of the memory for the learning model with aggregation and the usage of the memory for the learning model with no aggregation, which are calculated for each of the learning models.

4. The information processing apparatus according to claim 3, wherein
the determination processing is configured to:
in response that a sum of the second memory amount for each of the plurality of learning models exceeds a capacity of the memory mounted on the GPU, determine to preferentially aggregate sets of processing performed by the plurality of learning models in descending order of a difference between the first memory amount and the second memory amount.

5. The information processing apparatus according to claim 3, wherein
the determination processing is configured to:
in response that the second memory amount for each of the plurality of learning models falls within a capacity of the memory mounted on the GPU, determine not to aggregate the sets of processing performed by all of the plurality of learning models.

6. A non-transitory computer-readable storage medium storing an aggregation control program of controlling a plurality of application, each of the plurality of applications being an application performing processing on a moving image using a graphical processing unit (GPU), the aggregation control program causing a processor to perform an aggregation control processing comprising:
obtaining, for each of the plurality of applications, identification information of, among a plurality of learning models, a learning model to be used by the processing of that application, an operation cycle of the processing of that application, a processing time length requested for one frame of the processing of that application, and usage of the memory by the learning model;
executing a determination processing that determines, for each of the plurality of learning models by using various information stored for each of the plurality of the applications, aggregation necessity indicating whether to aggregate sets of processing performed by applications which are any two or more of the plurality of applications and use that learning model, and a number of processes to be used for the aggregation, each of the applications being an application using that learning model, wherein the various information includes the identification information of that learning models, the operation cycle, the processing time length, and the usage of the memory by that learning model; and
in response to the determining of the aggregation necessity indicating that the sets of processing performed by the applications are to be aggregated, executing an execution processing that aggregates and executes the sets of processing performed by the applications, by using a process different from a process for performing the applications.

7. A computer-implemented aggregation control method for controlling a plurality of application, each of the plurality of applications being an application performing processing on a moving image using a graphical processing unit (GPU), the aggregation control method comprising:
obtaining, for each of the plurality of applications, identification information of, among a plurality of learning models, a learning model to be used by the processing of that application, an operation cycle of the processing of that application, a processing time length requested for one frame of the processing of that application, and usage of the memory by the learning model;
executing a determination processing that determines, for each of the plurality of learning models by using various information stored for each of the plurality of the applications, aggregation necessity indicating whether to aggregate sets of processing performed by applications which are any two or more of the plurality of applications and use that learning model, and a number of processes to be used for the aggregation, each of the applications being an application using that learning model, wherein the various information includes the identification information of that learning models, the operation cycle, the processing time length, and the usage of the memory by that learning model; and
in response to the determining of the aggregation necessity indicating that the sets of processing performed by the applications are to be aggregated, executing an execution processing that aggregates and executes the sets of processing performed by the applications, by using a process different from a process for performing the applications.
